(19) United States
(12) Patent Application Publication
(10) Pub. No.: US 2004/0126535 A1
(43) Pub. Date: Jul. 1, 2004

(54) Process for producing hollow bodies comprising fiber-reinforced ceramic materials

(76) Inventors: Arno Sommer, Wehringen (DE); Dieter Huber, Augsburg (DE); Dunja Straub, Donauwoerth (DE); Vahid Shafi, Meitingen (DE)

Correspondence Address: ProPat, L.L.C., 2912 Crosby Road, Charlotte, NC, 28211-2815, US

(21) Appl. No.: 10/624,696

(22) Filed: Jul. 22, 2003

(30) Foreign Application Priority Data
Jul. 29, 2002 (DE) 102 34 400.0

(51) Int. Cl. B32B 3/02; C01B 31/00

(52) U.S. Cl. 428/66.2; 428/66.6; 264/29.1

(57) ABSTRACT

A process for producing hollow bodies comprising fiber-reinforced ceramic materials, in which a green body comprising compressible cores and a press moulding composition comprising binder and fiber material which is pressed with compression of the core is produced, the green body is cured and carbonized and pyrolyzed by heating in a nonoxidizing atmosphere and, if desired, is silicized, hollow bodies produced in this way and their use, in particular as brake and clutch discs

### FIELD OF THE INVENTION

The present invention relates to a process for producing hollow bodies comprising fiber-reinforced ceramic materials. In particular, the invention relates to a process for producing a porous fiber-reinforced carbon-containing shaped body having recesses or hollow spaces, in particular a fiber-reinforced C/C body (carbon fiber reinforced carbon, “CFRC” or “CFC”), which is close to its final contours by shaping binder-containing fiber compositions by means of a pressing process using pressing cores and converting the resulting body into C/C in a subsequent thermal treatment, and also to the optional post-densification of this porous fiber-reinforced carbon-containing shaped body to form a ceramic matrix, in particular by liquid metal infiltration into the C/C body, if appropriate with subsequent thermal treatment, so that the matrix then comprises metals and the metal carbides formed by reaction with the carbon and possibly residual unreacted carbon.

For the purposes of the present invention, the term “metals” refers to all elements which form carbides which are solid at room temperature, i.e. including, in particular, silicon.

The process of the invention relates particularly to the production of ceramic composites which are reinforced with carbon fibers and have recesses and hollow spaces and which are converted by liquid metal infiltration with silicon melts and reaction of at least part of the carbon to form silicon carbide into composites which have a SiC-SGL containing or carbon- and SiC-containing matrix and are reinforced with carbon fibers (C/SiC or C/C-SiC materials). These composites are employed, in particular, in brake, clutch and friction discs, and also as high-temperature-resistant construction materials.

### BACKGROUND OF THE INVENTION

Materials used predominantly at present for brake discs in automobile construction are steel or gray cast iron, and in aircraft, carbon materials reinforced with carbon fibers (C/C). The properties required of the disc materials are high mechanical stability, heat resistance, hardness and wear resistance against the friction partner in the friction pairing of the brake. The use temperature of gray cast iron brake discs employed hitherto is limited by the melting point of the material. The mechanical failure temperature is, depending on the load, even significantly below the melting temperature. Furthermore, due to transformation of the metallic microstructure on heating, there is a risk of crack formation in the discs. The use of fiber-reinforced ceramic as material for brake disc applications has been found to be a solution to these problems. Materials based on silicon carbide reinforced with carbon fibers (C/SiC) have been found to be particularly useful for this application. Advantages of this material are their relatively low density (therefore lower weight at the same volume), the high hardness and heat resistance to about 1400° C. and, not least, the extremely high wear resistance. The significantly lower weight of brake discs made of these C/SiC materials is found to be a positive influencing factor for improving comfort and safety by reducing the unsprung masses in motor vehicles and as an economic factor in aircraft applications. The high hardness and wear resistance of C/SiC components makes it possible to achieve far higher operating lives than is the case for hitherto customary materials based on C/C or metal.

Processes for producing C/SiC components are known, for example from the patent application DE-A 197 10 105, and comprise, inter alia, the following steps:

production of a pressable mixture of carbon-containing fibers or fiber bundles (hereinafter referred to as “fiber material”), which may be coated with a coating, with fillers and/or binders such as resins and/or pitch,

shaping of the mixture under pressure and at elevated temperature and carbonization of the carbon-containing fillers and binders to produce a shaped body, in particular a shaped body comprising carbon reinforced with carbon fibers (C/C), and, if desired, graphitization,

infiltration of at least an outer zone of the shaped body with a silicon melt and at least partial reaction of the silicon with the carbon in the shaped body to give SiC, thus forming a shaped body which at least in its outer zone consists of a composite ceramic comprising carbon-containing fibers embedded in a matrix comprising predominantly SiC, Si and C (likewise referred to here as C/SiC).

Hereinafter, the term C/SiC generally also refers to the material variant in which, as described above, only an outer zone is silicized.

Customary production processes also include those where the C/C body is further densified via the liquid or gas phase with carbon precursors (substances which form carbon on heating in the absence of oxidizing media) or with carbon, or in which the matrix comprising predominantly SiC, Si and C is produced by gas-phase infiltration (CVD, chemical vapor deposition, or CVI, chemical vapor infiltration) or by pyrolysis of Si-containing preceramic polymers.

Present-day metallic brake discs frequently have ventilation slits or channels through which air flows within the disc in order to reduce the temperature level of the disc and to reduce wear of the friction linings under high load. Such ventilation channels are also produced in brake discs based on C/SiC, in particular to reduce the temperature level so as to spare the brake linings and further system components.

A process for producing friction units comprising C/C-SiC material with ventilation channels, hollow spaces and recesses, in which a porous carbon body structured so as to be close to the final contours is infiltrated with silicon, is known from EP-B 0 788 468. This process makes use of the fact that liquid silicon infiltration and formation of the Si- and SiC-rich matrix of the composite occurs virtually without a change in the geometry of the C/C intermediate body, so that the hollow spaces and recesses can be produced in the relatively soft and readily machinable C/C intermediate body rather than in the very hard C/C-SiC composite ceramic. It is proposed, inter alia, that the hollow spaces and recesses be formed by means of soluble cores of polystyrene foam or other rigid foams, by means of pyrolyzable cores of polyvinyl alcohol or by means of cores of rubber, wood, metal or ceramic. The material of the cores replicates the ventilation channels of the friction unit with the webs between the individual ventilation channels being formed in corresponding empty spaces within the core material.

The fiber-containing press moulding compositions used in the production of ceramics reinforced with short fibers can in general be introduced into the press mould only as a relatively loose particulate material. For this reason, high compaction ratios of the press moulding composition or long distances of travel of the punch are necessary to produce green bodies having an acceptable density. In the disc-shaped zone within the press moulding composition in which the cores are located (hereinafter also referred to as “core zone”) or in the empty spaces between the cores, the press moulding composition can fill these empty spaces only incompletely, since the flow of the press moulding composition is hindered by the cores bounding the empty spaces. The compaction ratio in the core zone, namely in the empty spaces and intermediate spaces between adjacent cores, is therefore always lower than in the layers of material located above and below the core zone. The fiber content in these regions is lower than in the remaining material because of the lower degree of compaction. This can have a particularly damaging effect on the mechanical properties of the fiber-reinforced ceramics.

For the purposes of the present invention, short fibers are fibers having a mean length of not more 50 mm.

The situation can be remedied, inter alia, by the press moulding composition in the empty spaces between the cores being precompacted by means of suitable punches. However, this procedure has a number of disadvantages. Firstly, it complicates the process since, inter alia, the additional process steps of filling the spaces between the cores with the press moulding composition and precompacting this are added to the normal pressing process. Suitable pressing tools would have to have punches in a plurality of planes of which those in the region of the recesses of the cores can be moved separately from the rest of the pressing tool. Furthermore, a boundary layer or a material and microstructure phase boundary between the precompacted regions in the core zone and the layers above or below them can be formed. This has a damaging effect on, in particular, the mechanical properties of the ceramic composite obtainable in this way.

It is therefore an object of the invention to provide a process and a core material matched thereto, by means of which it is possible to obtain fiber-reinforced hollow ceramic bodies which do not have a lower fiber density in the core zone (more precisely in the spaces filled by press moulding composition between the cores) than in the layers above or below, and which have no phase boundary at the transition between the material of the core zone and the material of the layers above or below the core zone. Furthermore, the cores should be able to be removed from the hollow body in a simple manner without causing damage.

### SUMMARY OF THE INVENTION

According to the invention, this object is achieved by, in a pressing process using a punch covering the entire area of the pressed body, providing compressible cores which experience a length change of at least 5%, at least in the direction of travel of the punch during the pressing procedure, with the cores comprising a material which is either pyrolyzed completely during the further thermal treatment of the fiber-containing intermediate body or is at least partially decomposed with a volume shrinkage.

The invention accordingly provides a process for producing hollow bodies comprising fiber-reinforced ceramic materials, which comprises

in a first step, producing compressible cores whose shape corresponds essentially to the geometry of the hollow spaces to be formed, at least in the plane perpendicular to the pressing direction,

in a second step, producing a green body by introducing the abovementioned compressible cores and a press moulding composition comprising binder and fiber material into a mold,

in a third step, pressing the fiber-containing composition, with the core being compressed, at least in the pressing direction, by at least 5% of its dimension in the pressing direction,

in a fourth step, curing the fiber-containing composition, preferably by heating to a temperature of from 120° C. to 280° C., where the third and fourth steps can also be carried out simultaneously or partly overlapping in time,

in a fifth step, carbonizing the cured green body, also referred to as intermediate body, by heating to a temperature of from about 750° C. to about 1100° C. in a nonoxidizing atmosphere to give a C/C body, and, if desired,

in a sixth step, infiltrating the C/C body with a liquid metal while retaining its shape, with at least partial reaction of the carbon in the matrix of the C/C body with the metal occurring to form carbides, where the compressibility of the cores permits, under the pressing conditions, a length change in the pressing direction of at least 5% and the cores comprise material which, in the fifth step, pyrolyzes or is at least partially pyrolyzed with a reduction in volume.

For the present purposes, a composition is referred to as “pressable” when it retains its shape and does not readily crumble when the pressure is released after compaction in the pressing process.

For the purpose of the present invention, a “fiber bundle” is a group of single fibers with parallel direction and at least approximately the same length.

The fiber-reinforced hollow ceramic bodies produced by this process have a fiber density in the region of the core zone of the material which is not lower than that in the layers above and below the core zone and which can be adjusted via the height of the compressible core and display no phase boundaries at the transition between the core zone and the adjoining layers of material.

This is achieved according to the invention by using compressible cores which can be compressed at least in the pressing direction during the pressing procedure in this process. The length change can be set in a targeted manner via the material, height and type of the lost core. Compared to a process using rigid cores, a greater fill volume of the mould is made available in this way. During the pressing procedure, the compressible core is compressed to a predeterminable length, which enables the compaction ratio of the pressable composition in the spaces between the cores to be adjusted.

Preference is given to cores which can be compressed by at least 5% of their initial length during pressing. The recovery of the material is preferably sufficiently small for the cured green body not to be damaged on release of the pressure. For this reason, elastomers or rubber, for example, are not suitable as core material.

The linear compressibility of the cores used according to the invention, i.e. the relative change in length in the direction of travel of the punch, is at least 5% of the initial length. The cores are preferably compressed in the pressing direction to from 2 to 80%, particularly preferably to from 5 to 25%, of their initial length.

The stiffness of the cores is chosen so that a pressing pressure in the range from 0.1 to 50 MPa is sufficient to achieve the desired compression.

In general, preference is given to using core materials whose melting point is above the curing temperature of the green body.

In one embodiment of the invention, the cores are made of fusible materials which are selected from among thermoplastic polymers (plastics) which can be pyrolyzed without leaving a residue, hereinafter also referred to as thermoplastic cores. According to the invention, the thermoplastic material for the core is selected so that its melting point is above the curing temperature of the shaping process for the green body, typically in the range from 120 to 300° C., but significantly below the carbonization temperature of the pressed and cured green body. The melting point is usually at least 150° C., preferably at least 180° C. and particularly preferably in the range from 220° C. to 280° C. However, if thermal curing of the pressable mixture is carried out only after the punch and die of the press have been brought together to the final dimensions, it is also possible to use core materials which melt or are decomposed at or below the curing temperature, since the pressable composition has in this case already assumed its final shape. If phenolic resins are chosen as binders for the pressable mixtures, the melting point of the thermoplastic is, for example, preferably above 150° C. In the case of the preferred shaping by pressing and hot curing of the binders, high demands are placed on the heat distortion resistance of the thermoplastic core. The heat distortion temperature (determined in accordance with ISO 75A) is usually above 80° C., particularly preferably at least 150° C. The hardness (ball indentation hardness) of the thermoplastic should be at least 30 MPa.

If thermoplastic polymers are used as material for the cores, the cores are preferably produced by an injection-molding process. The known shaping processes such as cold or hot pressing, casting, pressure casting or cutting machining are generally suitable, depending on the material used.

Advantageous materials for compressible pressing cores are foamed polymers. Here, preference is given to thermoplastic polymers, in particular those which can be pyrolyzed without leaving a residue. Particularly useful polymers are polyamides (PA) such as PA 66, polyimides (PI) such as polyetherimide (PEI), polymethyl methacrylimide (PMMI) or modified polymethacrylimide (PMI), polyoxymethylene (POM) and polyterephthalates (PETP, PBTP) and also their copolymers. Particularly useful polymer foams are PMI foam and foamed polystyrene.

Apart from polymers which pyrolyze without leaving a residue at temperatures of at least 750° C., polymers which are only partially pyrolyzed or carbonized are also suitable, as long as a significant volume shrinkage (at least 50%) takes place. Such polymers include, inter alia, thermosets such as phenolic resins or rigid foams formed from these. It is also possible for the cores to be made of mixtures of materials of which one part pyrolyzes without leaving a residue and another part loses its original shape during pyrolysis to such an extent that it is present in the mold as a loose powder or nonadherent grains.

However, it is likewise possible to use loose polymer spheres.

In a further advantageous variant of the invention, multilayer cores of foamed polymers in sandwich-like structures are used. In this case, at least one of the upper or lower surfaces of the core is covered with a hard polymer which is infusible under the curing conditions, in particular a carbonizable polymer. Particular preference is given to both the upper surface and the lower surface of the core being covered by such a layer. This ensures that the press moulding composition is not in direct contact with the relatively soft compressible material comprising polymer foam over a large area, which could lead to nonuniform compression of the core material due to irregularities in the uncompacted press moulding composition. This would result in a corrugated, rough and uneven surface of the hollow space formed later. The stronger material on the surfaces of the soft core results in the pressing pressure being distributed uniformly over the compressible region of the core, so that smooth and flat surfaces are formed in the green body. The material which covers the soft cores is preferably at least partially decomposed at temperatures of at least 250° C. with a volume shrinkage.

In a further variant, the hard material in the “sandwich structure” is formed by a wood material, for example compressed wood or particle board, at the upper and/or lower boundaries of the core.

A further advantageous variant provides multipart cores whose individual parts can be moved relative to one another under the action of pressure. In such an embodiment, the core consists of two half cores or half shells of which the first has empty spaces in its interior which can accommodate the second half core. The two half cores are initially held together by adhesive bonding or by means of a clip connection and can be introduced into the mould in this form. Only after application of the pressing pressure does the adhesive bond or the clip connection rupture, so that the second half core can be pushed into the first. The first core acts as the guide for the second. The distance traveled by the second core can be set precisely by means of projections in the empty space of the first core or by the depth of the empty space.

The process of the invention provides for press moulding compositions comprising carbon fibers, thermally curable binders and additives, in particular carbon-containing additives, to be introduced together with the above-described cores into the pressing mold in the second step. This fixes the geometry of the body formed.

The carbon fiber layers of the C/C intermediate body in the vicinity of the core are preferably built up on the core in a predetermined preferential direction of the carbon reinforcing fibers. For this purpose, preference is given to using press moulding compositions which contain carbon fibers having a mean length of at least 5 mm. Particular preference is given to press moulding compositions which contain carbon fibers in the form of short fiber bundles having a mean length of not more than 50 mm and in which the fibers have a coating of pyrolytic carbon formed by carbonization of polymers, resins or pitches. The press moulding composition is then preferably introduced into the mold so that the carbon fibers are predominantly oriented parallel to the direction of the maximum tensile stress in the resulting shaped part. This usually means at least 50%. It is also possible for carbon threads laid parallel to one another and bound together (“tapes” or “UDT”=unidirectional tapes) to be wound around the cores and this envelope to be fixed, if desired, by means of thermally curable binders. Further press moulding compositions having a shorter fiber length or fiber bundle length are then usually placed in layers on top of this layer of preferentially oriented carbon fibers or threads.

In another preferred embodiment, carbon fibers are used in the form of coated short fiber bundles. Particular preference is given to fibers or fiber bundles having mean lengths of less than 5 mm coated with graphitized carbon.

As thermally curable binders, use is made of pitches such as coal tar pitch or petroleum pitch and/or preferably curable resins such as phenolic resins, epoxy resins, polyimides, filler-containing mixtures with furfuryl alcohol or furan resins. The compositions are introduced into a mould provided with lost cores. The cores occupy the space which is later to be the hollow or empty spaces to be produced in the composite ceramic body.

In the third step, after filling of the mold, the required pressure is applied by means of the punch and the composition is pressed to form green bodies having hollow spaces and/or empty spaces.

In the fourth step, the pressed body is cured under the action of heat. Curing can be carried out separately, i.e. after pressing, for example in a furnace. It is also possible to commence curing during pressing in a heatable press, either simultaneously with pressing or after a time delay. Curing in the mold makes fewer demands on the cohesion of the pressed but still uncured body.

After curing, the crosslinked green body together with the thermoplastic core is, in the fifth step, converted into the C/C state, i.e. carbonized. This is generally achieved by heating to temperatures in the range from about 750° C. to 1100° C. under a protective gas blanket (nitrogen) or under reduced pressure. If the body is heated to temperatures above about 1800° C., graphitization of the carbon additionally takes place.

After carbonization of the green body, any pyrolysis residues or carbon residues in the hollow spaces formed are removed to give a porous C/C body which has hollow spaces or empty spaces and can be utilized further. It can be subjected to further machining or can in turn be assembled or adhesively bonded to form more complex structures.

In a preferred embodiment of the process of the invention, the carbon of the C/C body is, in the sixth step, converted at least partially into carbides by melt infiltration with metals and, if appropriate, subsequent heat treatment. Preference is given to melt infiltration with silicon, resulting in at least part of the carbon (preferably the carbon in the matrix) being converted into silicon carbide; the matrix then comprises SiC, unreacted carbon and unreacted silicon. For this purpose, the C/C body is covered with silicon powder and heated under reduced pressure to temperatures of from about 1500 to about 1800° C. Depending on the intended use, it is not absolutely necessary to convert the entire C/C body into C/SiC; however, at least the outer layer is generally converted into C/SiC. Although silicon melt infiltration is the preferred process, the C/C body can also be further densified using other customary methods to form the matrices customary in composites technology. In particular, the liquid silicization process can also be carried out using silicon alloys which may further comprise, inter alia, metals such as chromium, iron, cobalt, nickel, titanium and/or molybdenum.

The process described is preferably used for producing brake discs or clutch discs. Here, the press moulding composition and at least one core are placed in a cylindrical mold. The thickness of the bottom layer and covering layer (below and above the core zone) is preferably at least 7 mm after pressing. These layers form the friction layers of the brake or clutch disc. The shape of the brake or clutch disc is preferably that of an annular disc, i.e. the region close to the axis is empty over the entire thickness of the disc. The shape and arrangement of the core or cores is preferably such that the hollow spaces formed extend from the periphery of the cylindrical shaped body to the inner edge of the shaped body and thus form an open passage between the inner and outer cylindrical surfaces of the annular disc. In this way, internally ventilated brake or clutch discs having radial ventilation channels are produced.

The process of the invention makes it possible to obtain brake and clutch discs in which the volume fractions of reinforcing fibers in the core zone and that in the (solid) layers above and below it differ by not more than 30%, preferably not more than 20% and particularly preferably not more 15%. In particular, a maximum deviation of 10% can be achieved by a suitable combination of thickness and compressibility of the core. This combination can be determined for each choice of press moulding composition and core material, shape and number of cores and pressing pressure applied by means of a series of tests. The compressible cores even make it possible to obtain a volume fraction of reinforcing fibers in the core zone which is above that in the zones above and below it; it can be preferably from 5 to 30% higher than the volume fraction in the adjoining zones, particularly preferably up to 20% higher and in particular up to 15% higher. The process makes it possible to obtain a continuous transition between the zones having a different fiber content; no step change which would, for example, manifest itself as a line or streak on the photograph of a section or polished section is found.

The process of the invention is illustrated by the figures. In the figures,

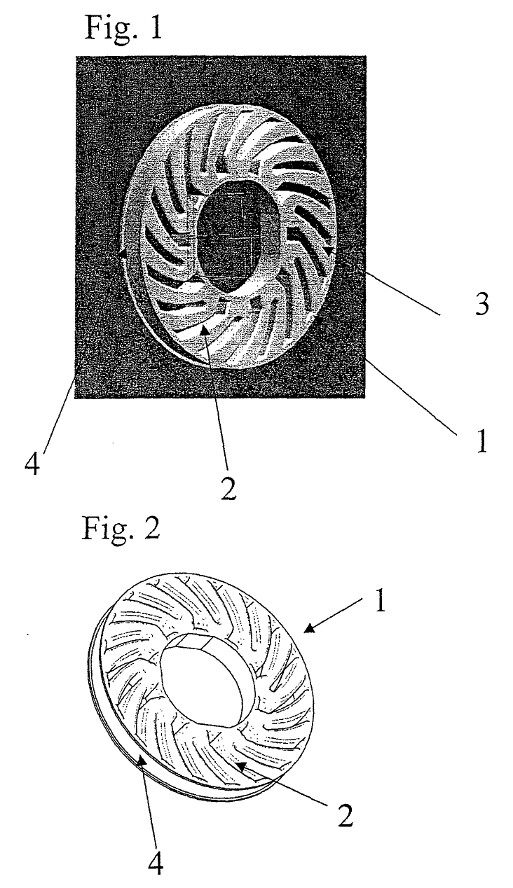

FIG. 1 shows a perspective photograph of a core suitable for the process of the invention,

FIG. 2 shows a perspective view of the same core at a different angle of view,

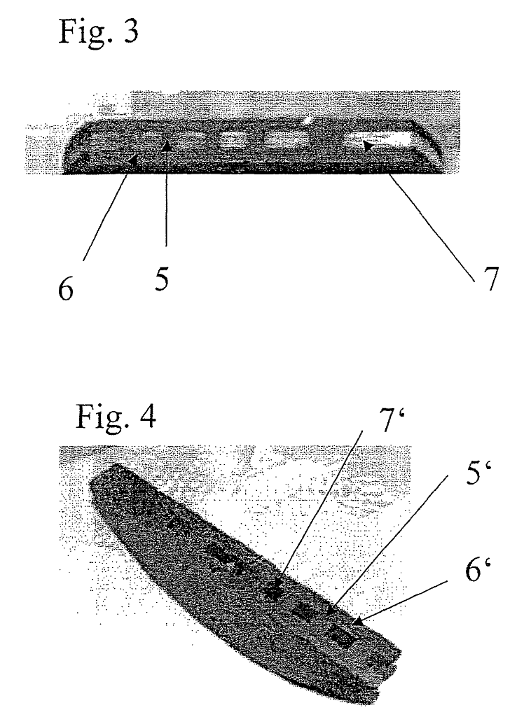

FIG. 3 shows a photograph of a green body cut at a distance from the axis of rotation prior to carbonization, and

FIG. 4 shows a photograph of a brake disc cut at a distance from the axis of rotation after infiltration with silicon.

The oblique view of FIG. 1 shows a core 1 in which the hollow spaces 2 are visible. In the region of the hollow spaces 2, the material of the core zone of the brake disc is formed from the composition introduced between the parts 3 of the core in the core zone. FIG. 2 shows the same core from a different angle of view.

FIG. 3 shows a section through the pressed and cured green body after the fourth process step; the compressed cores 7 are surrounded by webs 5 of the press moulding composition. The identical gray coloration of the material of a lower covering layer 6 and the material in the core zone 5′ indicates that their density is the same.

FIG. 4 shows a section through the finished, silicized brake disc after the sixth process step; here, too, the density in the region of an upper silicized covering layer ₆′ above the core zone 5′ is the same as that in the core zone 5′. The hollow spaces 7′ formed after pyrolysis at the site of the cores correspond to the cores as regards their shape and size.

The internally ventilated brake or clutch discs produced by the process of the invention can be used for brakes in automobiles and heavy goods vehicles, for aircraft and rail vehicles and also for friction clutches in drives of all types. Hollow bodies produced in this way can likewise be used in a variety of ways as components in the production of tools and in machine construction.

### List of Reference Numerals

1 Mold core

2 Hollow space

3 Parts of the core

4 Periphery

5 Webs

5′ Core zone

6 Lower covering layer

6′ Upper silicized covering layer

7 Core

7′ Hollow space

1. A process for producing hollow bodies comprising fiber-reinforced ceramic materials, which comprises
in a first step, producing compressible cores whose shape corresponds essentially to the geometry of the hollow spaces to be formed, at least in the plane perpendicular to the pressing direction,
in a second step, producing a green body by introducing the abovementioned compressible cores and a press moulding composition comprising binder and fiber material into a mold,
in a third step, pressing the fiber-containing composition, with the core being compressed, at least in the pressing direction, by at least 5% of its dimension in the pressing direction,
in a fourth step, curing the fiber-containing composition,
in a fifth step, carbonizing the cured green body, also referred to as intermediate body, by heating to a temperature of from about 750° C. to about 1100° C. in a nonoxidizing atmosphere to give a C/C body,
where the compressibility of the cores permits, under the pressing conditions, a length change in the pressing direction of at least 5% and the cores comprise material which, in the fifth step, pyrolyzes or is at least partially pyrolyzed with a reduction in volume.

2. The process as claimed in claim 1, wherein, subsequent to the fifth step,
in a sixth step, the C/C body is infiltrated with a liquid metal while retaining its shape, with at least partial reaction of the carbon in the matrix of the C/C body with the metal occurring to form carbides.

3. The process as claimed in claim 1, wherein
in the fourth step, the fiber-containing composition is cured by heating to a temperature of from 120° C. to 280° C.

4. The process as claimed in claim 1, wherein the third and fourth steps are carried out simultaneously or partly overlapping in time.

5. The process as claimed in claim 1, wherein multilayer cores comprising foamed polymers in sandwich-like structures in which at least one of the upper or lower surfaces of the core is covered by a hard polymer which is infusible under curing conditions are used.

6. The process as claimed in claim 1, wherein the press moulding compositions contain carbon fibers having a mean length of not more than 50 mm.

7. The process as claimed in claim 1, wherein the press moulding compositions contain bundles of carbon fibers having a mean length of less than 5 mm.

8. The process as claimed in claim 2, wherein the metal used for infiltration is silicon or a silicon alloy.

9. The process as claimed in claim 8, wherein the silicon alloy comprises a metal selected from among chromium, iron, nickel, cobalt, titanium and molybdenum.

10. A hollow body comprising fiber-reinforced ceramic material obtainable by the process of claim 1 in the form of an annular disc in which at least one hollow space extends from the periphery to the inner edge of the annular disc.

11. A method of use of a hollow body as claimed in claim 10 as brake or clutch disc comprising forming annular discs by press moulding of a carbon-fiber reinforced body, curing and carbonizing said body, and infiltrating the carbonized body with silicon or a silicon alloy under formation of the respective carbides.
